(19) United States
(12) Patent Application Publication
(10) Pub. No.: US 2013/0110610 A1
(43) Pub. Date: May 2, 2013

(54) SYSTEM AND METHOD FOR ENABLING USE OF LOYALTY PROGRAM POINTS AS A STORED VALUE PAYMENT DEVICE

(71) Applicant: Switchfly, Inc., San Francisco, CA (US)

(72) Inventor: Christopher Boyd, Oakland, CA (US)

(73) Assignee: SWITCHFLY, INC., San Francisco, CA (US)

(21) Appl. No.: 13/665,680

(22) Filed: Oct. 31, 2012

Related U.S. Application Data
(60) Provisional application No. 61/553,495, filed on Oct. 31, 2011.
(60) Provisional application No. 61/645,527, filed on May 10, 2012.

(51) Int. Cl. G06Q 30/02

(52) U.S. Cl. 705/14.27

(57) ABSTRACT

A method and system for enabling use of loyalty program points as a stored value payment device. In one preferred embodiment, the method may include the steps of receiving, from a first computer associated with a user, a desired value of the stored value payment device; determining a pricing factor applicable to at least one of the user and the desired value of the stored value payment device; converting the desired value of the stored value payment device based on the pricing factor to an equivalent value; sending, to the first computer associated with the user, the determined equivalent value; debiting a number of loyalty program points from user's loyalty program account; and creating a stored value payment device having an initial real-time debitable balance equal to a cash value. In one preferred embodiment, the system may include a controller, a rules engine, and a payment device.

### CLAIM OF PRIORITY

The present application claims priority to: U.S. Provisional Patent Application Ser. No. 61/553,495 entitled “Method for enabling use of loyalty program points as branded stored payment” and filed 31, Oct. 2011; and U.S. Provisional Patent Application Ser. No. 61/645,527 entitled “Method for enabling use of loyalty program points as branded stored payment” and filed 10, May 2012, which are both incorporated in their entirety by this reference

### TECHNICAL FIELD

This invention relates generally to the loyalty program rewards field, and more specifically to a new and useful system and method for enabling use of loyalty program points as a stored value payment device in the loyalty program rewards field.

### BACKGROUND

Internet technology has revolutionized travel management, providing user-friendly online booking. Many loyalty programs encourage loyalty by awarding loyalty program points to users for purchases with the same supplier, i.e. the supplier of the loyalty program. The users may then redeem these loyalty program points for further travel or other related goods or services. However, present day redemption systems are inefficient and limited in options. Many loyalty rewards programs, such as frequent flyer programs, have restrictions on how rewards (e.g., points or miles) may be used or redeemed. Conventionally, users may only redeem their loyalty program points for goods and services that are directly related to travel—other flights, hotels, tours, rental cars, and the like. Furthermore, loyalty program members are currently limited to a slim catalog when redeeming points for merchandise.

A primary requirement and limitation for conventional loyalty programs is that the user interact directly with the loyalty program as a point of sale, instead of, for example, with some transitional currency. Thus, there is a need in the loyalty program rewards field to create a new and useful system and method for enabling use of loyalty program points as a stored value payment device in the loyalty program rewards field.

### BRIEF DESCRIPTION OF THE FIGURES

FIG. 1 is a schematic of the system of a preferred embodiment;

FIG. 2 is an illustrative exemplary user interface of the system of a preferred embodiment;

FIG. 3 is an illustrative exemplary table in the pricing factors database of the system of a preferred embodiment; and

FIGS. 4-7 are flowcharts depicting the method of a preferred embodiment and variations thereof.

### DESCRIPTION OF THE PREFERRED EMBODIMENTS

The following description of preferred embodiments of the invention is not intended to limit the invention to these preferred embodiments, but rather to enable any person skilled in the art to make and use this invention.

### System for Enabling Use of Loyalty Program Points as a Stored Value Payment Device

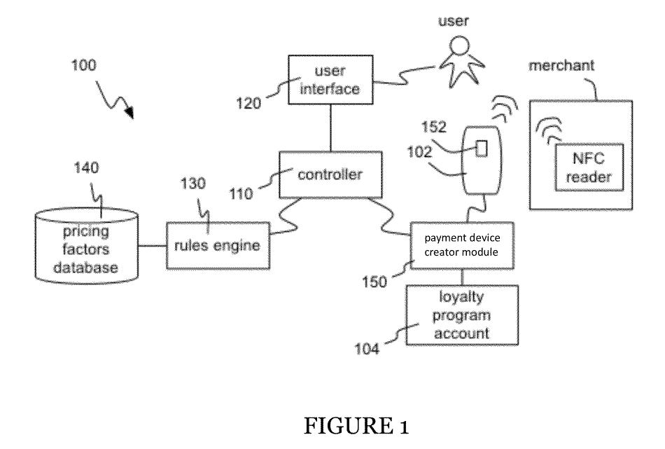

As shown in FIG. 1, the system 100 of a preferred embodiment for enabling use of loyalty program points as a stored value payment device includes: a controller 110 coupled to a loyalty program account 104 of a user and configured to receive from a user a desired value of the stored value payment device, and to convert the desired value of the stored value payment device based on the pricing factor to an equivalent value; a rules engine 130 coupled to the controller 110 and configured to determine the applicable pricing factor; and a payment device creator module 150 configured to debit a number of loyalty program points from the user's loyalty program account 104 and to create a stored value payment device 152 having an initial real-time debitable balance equal to a cash value. In one preferred embodiment, the desired value is entered as a cash value, the desired cash value is converted to an equivalent number of loyalty program points, and the payment device creator module 150 debits the equivalent number of loyalty program points from the user's loyalty program account 104 and creates a stored value payment device 152 with a balance equal to the desired cash value. In another preferred embodiment, the desired value is entered as a number of loyalty program points, the desired number of points is converted to an equivalent cash value, and the payment device creator module 150 debits the desired number of loyalty program points from the user's loyalty program account 104 and creates a stored value payment device 152 with a balance equal to the equivalent cash value.

The system 100 preferably provides an additional manner in which users or customers (loyalty program members) can redeem or utilize their loyalty points with loyalty programs (such as a frequent flyer program for an airline), which is preferably advantageous for the participating loyalty program, customers, and/or merchants accepting payments with the stored value payment device 152. The system 100 preferably reduces liability of accruing loyalty points for the loyalty program, and provides loyalty programs with virtually constant, real-time engagement with customers wherever the customers are. Furthermore, the system 100 provides a widely available loyalty program points redemption option for the customer, thereby increasing value of the loyalty program points. Even further, the system 100 provides, in the stored value payment device 152, an additional form of payment for participating merchants (e.g., merchants with NFC readers), thereby increasing transaction volume for the participating merchants.

The controller 110 preferably functions to oversee the creation of the stored value payment device 152. The controller 110 preferably receives, from a user, their desired value of the stored value payment device. The controller may receive this information in the form of a cash value (e.g. $250), a number of loyalty program points (e.g. 25,000 points or miles), or any other suitable indication of a desired value of the stored value payment device. The value information received from the user establishes the desired value of the stored value payment device 152.

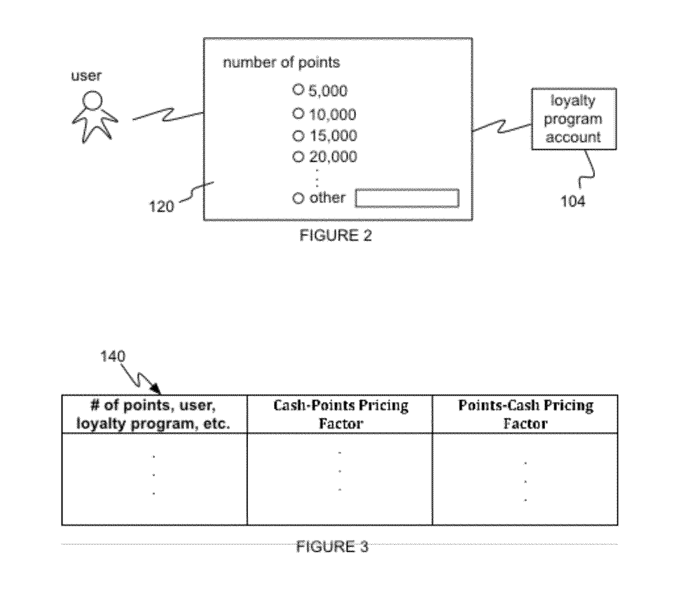

In a preferred embodiment, the system 100 further includes a user interface 120 for display on a computing device and coupled to the controller 110, for directly receiving the value information from the user. For example, the user interface may receive either a number of loyalty program points or a cash value input from the user indicating the user's desired value of the stored value payment device. In a preferred variation, the user interface 120 is hosted on a website, more preferably a website of the loyalty program, such as a co-branded website similar to that described in U.S. Pat. No. 8,024,664 entitled “Co-brands for User Interface in Travel Booking”, which is incorporated herein by this reference. However, the user interface 120 can be displayed in any suitable manner. The user interface 120 preferably receives user identification and/or a member login into a particular loyalty program. As shown in FIG. 2, the user interface 120 preferably displays at least one field that receives user input, such as a field designated for receiving a text of a number of loyalty program points desired by the user. Additionally or alternatively, the user interface 120 can display radio buttons, sliders, and/or any suitable interactive features for communicating a desired value of the card. The user interface 120 can display restrictions or other requirements, such minimum or maximum point limits or cash value limits, and/or preselected permissible numbers of points or currency (e.g., increments of 500 points or $50) that the user may select as desired value for the stored value payment device 152. The user interface 120 can be configured to display and/or receive any suitable desired value. The user interface 120 can further be configured to display and/or receive a selection of one or more particular merchant partners that the stored value payment device 152 can be affiliated with, if the stored value payment device 152 has particular specifications (e.g., different required point amounts, different value per loyalty program point) corresponding to each merchant partner.

The controller 110 preferably converts desired value of the stored value payment device based on a pricing factor to an equivalent value. Depending on the value information received, the equivalent value may be one of an equivalent cash value or an equivalent number of loyalty program points. For example, if the user inputs a desired cash value, the controller will convert the cash value to an equivalent number of loyalty program points. Alternatively, if the user inputs a desired number of loyalty points, the controller will convert the number of points to an equivalent cash value. The controller 110 is preferably configured to convert the desired value to an equivalent cash or points value based on a pricing factor.

The rules engine 130 preferably functions to determine the applicable pricing factor to the transaction. In a preferred embodiment, the rules engine 130 is communicatively coupled to a pricing factors database 140 of pricing factors that convert between values of loyalty program points and cash currency. The pricing factors database 140 is preferably configured to store a plurality of pricing factors associated with at least one of loyalty programs, target customer segments, merchants, desired value for the payment device, and any other suitable information. For example, the pricing factors can be stored in a lookup table. The pricing factors determine the conversion between a cash value (i.e., monetary currency) and a points value or number of points (i.e. loyalty program points, or “miles”).

As shown in FIG. 3, each factor preferably corresponds to a particular attribute of a particular customer (e.g. demographic, individual), and/or a particular merchant (e.g., type, location, individual), desired value, and/or any suitable categorization. The pricing factors database 140 is preferably stored on a server or other storage device that is accessible by one or more computing devices. In some embodiments, the pricing factors database can be coupled to or otherwise accessible by the loyalty program, such as to enable a loyalty program to specify and/or adjust a particular pricing factor value. The pricing factors database may be stored on a server, computer, or other storage device associated with or otherwise connected to the loyalty program such that representatives from the loyalty program may populate and control the data stored within the database directly. In this embodiment, the system may send a request to the loyalty program for the appropriate pricing factor given the target customer segment, the merchant, the desired value for the payment device, or any other suitable criteria.

The pricing factors database 140 is preferably configured to store various tiers of (cash-to-points and/or points-to-cash) pricing factors. As shown in FIG. 3, each tier can correspond to a particular number of loyalty program points, such that the value of each point varies depending on the total received number of loyalty program points. The value of the pricing factor can additionally or alternatively vary with any suitable parameter, such as user or member demographic (e.g., dependent on loyalty program “status” or how long the user has been a loyalty program member) or particular merchant partners (e.g., 100 loyalty program points can be worth more at Merchant A than at Merchant B). Alternatively, the applicable pricing factor can be constant, regardless of the total received number of loyalty program points, or based on an algorithm that calculates an applicable pricing factor. In a preferred embodiment, the rules engine 130 searches for, selects, or otherwise determines an applicable pricing factor from the pricing factors database 140. The applicable pricing factor is preferably communicated from the rules engine 130 to the controller 110, and the controller 110 preferably converts the received number of loyalty program points into an equivalent cash value by applying the pricing factor to the received number of loyalty program points. For example, the controller 110 can apply a pricing factor of 0.01 (dollars per point) to 20,000 loyalty program points to determine an equivalent cash value of $200 (20,000×0.01=200).

In a preferred embodiment, the rules engine 130 is implemented on a controller or a processor of a computing device, and can be configured to perform at least some of the processes described in the method below. In determining an equivalent value for the selected product, the controller 110 preferably communicates with the rules engine 130 to determine an appropriate pricing factor for the selected product. In one embodiment, the rules engine 130 determines the pricing factor by table lookup. In alternative embodiments, the rules engine 130 determines the pricing factor by algorithm or in any suitable process. As described above, the pricing factors are associated with at least one of loyalty programs, target customer segments, merchants, and desired values for the stored value payment devices. The rules engine 130 may select the pricing factor from the pricing factors database based on stored instructions, or may alternatively request and receive instructions (or the actual pricing factor) from the appropriate loyalty program. The pricing factor may be selected based on at least one of several factors including the loyalty program, the target customer segment, the merchant, and the desired values for the stored value payment devices. For example, different loyalty programs may offer different pricing factors to the same customer. For example, the customer may have more loyalty program points with a first program, and may therefore receive a more favorable conversion factor from that program. In some embodiments, the conversion factor may be selected based on the customer segment. For example, a premier or higher tier customer may receive a more favorable conversion factor and a lower level customer. In some embodiments, the conversion factor may be selected based on the merchant that the stored value payment device may be associated with. For example, loyalty programs may wish to encourage the use of points as a form a payment with a select few preferred merchants, and may therefore offer a more favorable conversion factor for those merchants. In some embodiments, loyalty programs may wish to encourage the use of a larger number of points as a form a payment, and may therefore offer a more favorable conversion factor when the desired value for the payment device is higher. In some embodiments, the conversion factor may be selected based on any other suitable criteria or a combination of any suitable criteria.

The payment device creator module 150 preferably functions to create the stored value payment device having an initial real-time debitable balance equal to a cash value. The cash value is preferably based on the determined equivalent cash value of the number of loyalty program points. The payment device creator module 150 preferably debits the number of loyalty program points from a loyalty program account 104 of the user, more preferably in real time. In a first variation of the payment device, the payment device creator module 150 creates a stored value payment device 152 as a standalone payment instrument (e.g., embedded within a mobile application on a mobile device) that stores the equivalent cash value of the debited number of loyalty program points.

In one variation, the stored value payment device 152 is a payment instrument compatible with near field communication (NFC) enabled devices 102, such as mobile phones. For example, the stored value payment device 152 can be a payment instrument usable with an e-commerce agent such as a mobile wallet and branded or otherwise associated with the loyalty program (e.g., with logos or other aspects of “look and feel”). However, the stored value payment device 152 can be a standalone payment instrument and/or generic payment instrument, such as a general-use VISA® card.

In particular, the stored value payment device 152 of the first variation can be operated independently of a central server handling real-time transactions. The stored value payment device 152 is preferably displayed on the mobile phone to the user with logos or other “look and feel” features of the particular loyalty program, which clearly associates the stored value payment device 152 with the loyalty program. Alternatively, the payment device can be displayed as an unbranded generic payment device (such as a general-use VISA® card) or as a customized payment device (such as with an uploaded photo or unique message).

In a second variation of the payment device, the payment device creator module 150 creates a stored value payment device 152 as a payment instrument compatible with a mobile phone or other NFC-enabled devices; for example, the stored value payment device 152 can be a payment instrument usable with a mobile wallet (or e-commerce agent such as PAYPAL). Like the first variation of the payment device, the second variation of the payment device 152 is preferably displayed on the mobile device or otherwise branded to clearly associate the payment device 152 with the loyalty program, but can alternatively be displayed as an unbranded generic payment device or customized payment device. In creating the stored value payment device 152 of the second variation, the payment device creator module 150 preferably links the equivalent cash value of the debited number of loyalty program points to an NFC tag and/or NFC-enabled device 102, such as a mobile phone. The process of creating an NFC tag is known and readily understood by one of ordinary skill in the art. Alternatively, the payment device creator module 150 can link the equivalent cash value of the debited number of loyalty program points to an instrument of another suitable communications standard, such as RFID or Bluetooth.

In a third variation of the payment device, the payment device creator module 150 can create (or facilitate creation of) a physical card (similar to a physical gift card loaded with cash value) having the determined equivalent cash value of the number of loyalty program points. This third variation might be preferable, for example, to users who are averse to or unfamiliar with mobile payments or other nonphysical forms of payment.

In some embodiments, the payment device creator module 150 can create a stored value payment device 152 with no restrictions that can be accepted as payment at any merchant. In some other embodiments, the payment device creator module 150 can create a stored value payment device 152 that is restricted to use at one or more particular merchants. The stored value payment device 152 can additionally or alternatively include other specifications such as an expiration date, or other limitations. In some embodiments, the payment device creator module 150 can divide the determined equivalent cash value into multiple stored value payment devices.

The payment device creator module 150 preferably functions to debit a loyalty program account of the user. More specifically, the payment device creator module is configured to debit a number of loyalty program points from the customer's account. The indication of an amount to debit can be received from the controller 110, directly from the user, and/or any suitable source. The number of loyalty program points debited is preferably equal to the equivalent cash value of the stored value payment device created. In some embodiments, however, the user may not be able to obtain their desired value for the payment device. For example, a user may input that they wish to create a card having a cash value of $500. The equivalent number of loyalty program points may be determined to be 50,000 points based on the pricing factor. However, the user may only have 25,000 points available for redemption in their loyalty program account. The user may be informed of this available balance. The user may then have the opportunity to either re-enter a desired cash value of $250 (or a points value of 25,000 points) or to opt to pay for the stored value payment device with a combination of points and cash. For example, the user may obtain a $500 payment device by paying $250 and 25,000 points for the card. In this example, the number of loyalty program points debited may be equal less than the desired value of the card. In some embodiments, the payment device creator module may be configured to debit a cash amount from a customers cash currency account, debit card, credit card, gift card, etc. In some embodiments, the cash payment methods may be linked, or otherwise associated with an e-commerce agent or payment partner wallet. In alternative embodiments, debits may include only cash currency or a combination of points and cash currency, similar to the system described in U.S. patent application Ser. No. 11/430,329 entitled, “Dynamic real-time point redemption in travel booking”, filed 08, May 2006, the entirety of which is incorporated herein by this reference.

After receiving a stored value payment device 152 branded by the loyalty program, the user preferably is able to make a purchase using the stored value payment device 152 at one or more merchants using his or her NFC-enabled device 102 (or other suitable carrier of the stored value payment device). During purchase, the NFC reader at the merchant preferably completes the purchase transaction and debits the purchase amount from the stored value payment device. The stored value payment device 152 can be configured such that after the transaction is complete, the user is able to view a notification message summarizing the purchase amount was debited from the stored value payment device 152.

### Method for Enabling Use of Loyalty Program Points as a Stored Value Payment Device

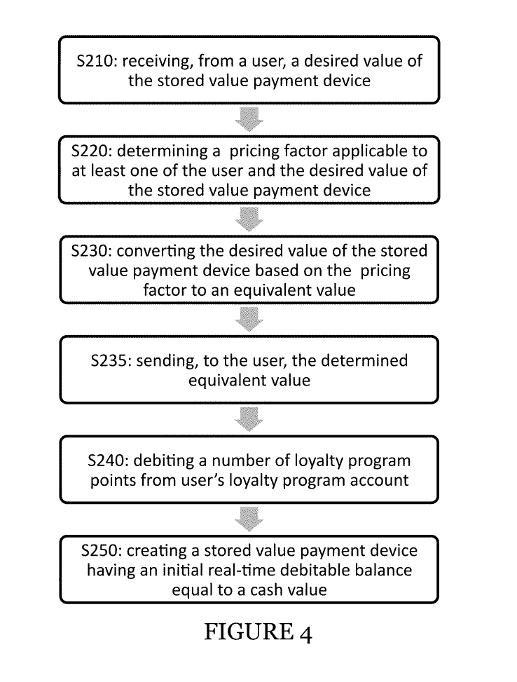

As shown in FIG. 4, a method of a preferred embodiment for enabling use of loyalty program points as a stored value payment device includes: receiving, from a first computer associated with a user, a desired value of the stored value payment device in block S210, determining a pricing factor applicable to at least one of the user and the desired value of the stored value payment device in block S220, converting the desired value of the stored value payment device based on the pricing factor to an equivalent value in block S230; sending, to the first computer associated with the user, the determined equivalent value in block S235; debiting a number of loyalty program points from user's loyalty program account in block S240; and creating a stored value payment device having an initial real-time debitable balance equal to a cash value in block S250. In one preferred embodiment, the desired value is received as a cash value, the desired cash value is converted to an equivalent number of loyalty program points, the equivalent number of loyalty program points is debited from the user's loyalty program account and the stored value payment device is created with a balance equal to the desired cash value. In another preferred embodiment, the desired value is received as a number of loyalty program points, the desired number of points is converted to an equivalent cash value, the desired number of loyalty program points are debited from the user's loyalty program account, and the stored value payment device is created with a balance equal to the equivalent cash value.

Similar to the system described above, the method preferably provides an additional manner in which users or customers (loyalty program members) can redeem or utilize their loyalty points with loyalty programs (such as a frequent flyer program for an airline), which is preferably advantageous for the participating loyalty program, customers, and/or merchants accepting payments with the stored value payment device. The method preferably reduces liability of accruing loyalty points for the loyalty program, and provides loyalty programs with virtually constant, real-time engagement with customers wherever the customers are. Furthermore, the method provides a widely available loyalty program points redemption option for the user, thereby increasing value of the loyalty program points. Even further, the method provides, in the stored value payment device, an additional form of payment for participating merchants (e.g., merchants with NFC readers), thereby increasing transaction volume for the participating merchants.

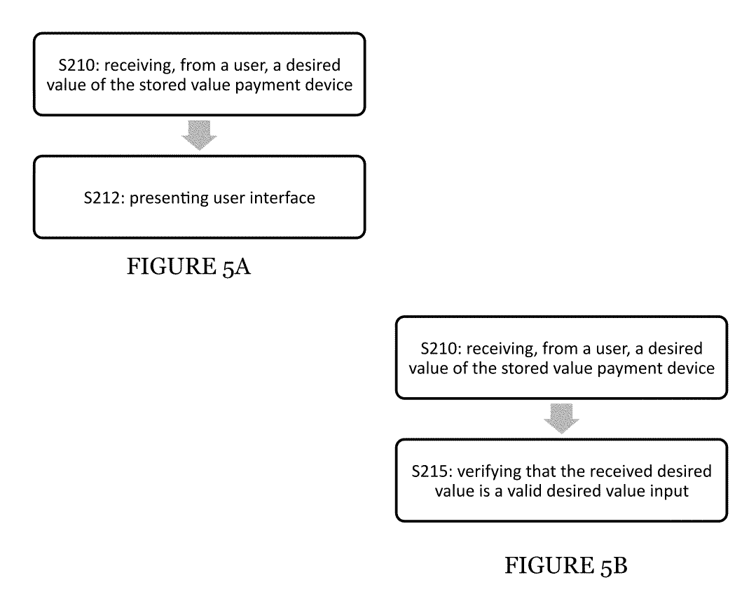

Block S210 recites receiving, from a first computer associated with a user, a desired value of the stored value payment device. Block S210 preferably functions to receive an indication of a value of a stored value payment device desired by the user. As shown in FIG. 5A, in a preferred embodiment, the method includes block S212, which recites presenting to the user a user interface that receives the desired value for the payment device. In a preferred variation, the user interface is hosted on a website, more preferably a website of the loyalty program, such as a co-branded website similar to that described in U.S. Pat. No. 8,024,664. However, the user interface can be displayed in any suitable manner. In this embodiment, the method can further include the steps of receiving loyalty program member identification (e.g., loyalty program login, user's name; loyalty program member identification information such as username, password, and member ID; payment partner identification information such as username and password; and any other suitable information), authenticating the user as a loyalty program member, and/or displaying a points balance in a loyalty program account of the user. In some embodiments, upon authenticating the user with the loyalty program, the method may further include the step of receiving profile information. Alternatively, in some embodiments, the member profile information may be stored, and updated, with the system described herein. A user's or member's profile information may include name, their current pricing factor or factors, current loyalty program points balance, number of points the user has available for purchases, the cash value of their total balance of loyalty program points, the cash value of the number of points the user has available for purchases, (alternatively, these numbers may be calculated from the pricing factor), current loyalty program customer segment (e.g. “gold”, “platinum”, “premium”, etc.), years as a member of the loyalty program, and any other suitable information. Additionally, the user information package may also include information about the loyalty program contract in general and/or specific to the user.

In one variation, as shown in FIG. 2, the method preferably includes the step of displaying, in the user interface, a field that receives a user-entered number value for the stored value payment device. This number may be a desired cash value, a desired number of loyalty program points, or any other suitable indication of desired value. In some embodiments, the desired value received may be in the form of both a cash value and a number of loyalty program points. In another variation, also shown in FIG. 2, the method preferably includes displaying, in the user interface, a plurality of selectable options for cash value and/or number values of loyalty program points (e.g., displaying radio buttons or a slider bar) and receiving a selection for a cash value and/or number value of loyalty program points.

In one embodiment, the method can include receiving a merchant selection, such that the created stored value payment device is related in some manner to the selected merchant (e.g., the stored value payment device is permissible only at with transaction at the selected merchant, value of the stored value payment device is higher in transactions at the selected merchant). However, the method can additionally or alternatively include receiving any suitable information related to the user and/or desires of the user through the user interface, or in any suitable manner.

In one embodiment, as shown in FIG. 5B, the method preferably includes block S215 which recites verifying that the received desired value is a valid desired value input. For example, the method can include verifying that the received desired value is equal to or less than the total points balance available for redemption in the loyalty program account of the user, above a minimum amount, below a maximum amount, meets particular increment requirements (e.g., the value is a multiple of 100), meets merchant specific requirements, meets loyalty program specific requirements, and/or any other suitable requirements. In some embodiments, the verifying step may further include the steps of authenticating the user with the loyalty program, querying the loyalty program for user profile information and/or contract information, and/or receiving user profile information and/or contract information from the loyalty program. Alternatively, the systems and methods described herein may store (and update) user profile information and/or contract information.

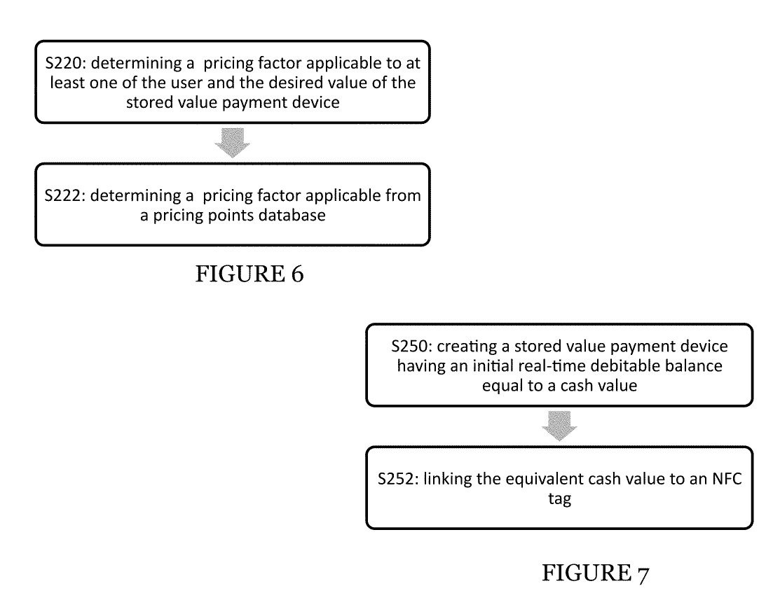

Block S220 recites determining a pricing factor applicable to at least one of the user and the desired value of the stored value payment device. The pricing factors preferably convert between values of loyalty program points and cash currency and vice versa. As shown in FIG. 6, in a preferred embodiment, the method includes block S222, which recites determining an applicable pricing factor from a pricing factors database 140, such as through a search query or table lookup. The pricing factors database 140 is preferably configured to store various tiers of pricing factors (cash-to-point and/or point-to-cash), and the tiers can be organized based on one or more parameters. The applicable pricing factor can be based on parameters such as the total number of loyalty program points available in the loyalty program account of the user, the received number value of loyalty program points (absolute number, or proportion of total loyalty program points available) to convert and load onto the stored value payment device, customer demographic, particular loyalty program, merchant partner (if applicable), date or time that the stored value payment device is being created, and/or any suitable parameter. Alternatively, the pricing factor can be a stored factor value and/or a factor value that is constant across all parameters.

In some embodiments, the conversion factor may depend on the user's customer segment. For example if the user is a premium customer (for example, they have a large balance of points, they recently purchased an expensive ticket, they have been a member for several years, they have a credit card associated with the loyalty program, etc.) they may receive a more favorable conversion factor than a user in a lower customer segment. A more favorable conversion factor may be one that provides a higher cash value for the same number of points.

Block S230 recites converting the desired value of the stored value payment device based on the pricing factor to an equivalent value. Block S230 preferably functions to establish the cash currency value of the stored value payment device. Additionally, in some embodiments, block S230 preferably functions to establish the number of loyalty program points to be debited from the user's loyalty program account. For example, if the user enters a desired cash value, block S230 functions to convert the desired cash value to an equivalent number of loyalty points. Alternatively, if the user enters a desired number of loyalty points, block S230 functions to convert the desired number of loyalty points to an equivalent cash value. In some embodiments, a user may enter both a cash value and a number of loyalty points and the method will convert both values to equivalent values. Depending on the received desired cash and loyalty point values, the equivalent loyalty point and cash values, respectively, may be determined based on different pricing factors.

In one specific example, the method may receive the desired value of 20,000 loyalty program points. Based on a determined pricing factor of 0.01 (dollars per point), block S230 determines that 20,000 loyalty program points has an equivalent cash value of $200 (20,000×0.01=200). The specific mathematical operation (such as multiplication or division) to convert the number value of loyalty program points in an equivalent cash value can vary depending on the nature of the pricing factor. Alternatively, the conversion can include any suitable mathematical operation of algorithm.

Block S235 recites sending, to the first computer associated with the user, the determined equivalent value. In some embodiments, the user interface as described in reference to block 5212 and FIG. 5A, may be further configured to display the determined equivalent value to the user. Block S235 (in some embodiments, in combination with block S212) functions to display to the user the determined equivalent value. As described herein, the determined equivalent value may be a cash value and/or a number of loyalty program points. Block S235 functions to allow the user to further understand the value of their stored value payment device. Furthermore, by displaying the determined equivalent value, the user may verify they are actually receiving their desired value for their stored value payment device. For example, if a user indicates that they would like a stored value payment device having a value of 20,000 loyalty program points, they may not have a complete understanding of the value of 20,000 loyalty program points. However, when the equivalent cash value of $200 (based on a pricing factor of $0.01/point) is determined and sent to the first computer associated with the user. The user may have a better understanding of the value of $200 as compared to the more abstract (and often variable) value of 20,000 loyalty program points.

In some embodiments, the step of sending, to the first computer associated with the user, the determined equivalent value may further include sending, to the first computer associated with the user, the determined equivalent value and any suitable loyalty program profile information. The user's loyalty program profile information may include, as described above, current loyalty program points balance, number of points the user has available for purchases, the cash value of their total balance of loyalty program points, the cash value of the number of points the user has available for purchases, current loyalty program customer segment (e.g. “gold”, “platinum”, “premium”, etc.), years as a member of the loyalty program, and any other suitable information.

In some embodiments, the method may further include the step of receiving, from a first computer associated with a user, a confirmation of the desired value of the stored value payment device upon the user receiving the determined equivalent value. In some embodiments, the method may further include the step of receiving, from a first computer associated with a user, a different desired value of the stored value payment device upon the user receiving the determined equivalent value. For example, the user may receive their number of points the user has available for purchases, and may wish to increase or decrease the number of points they wish to redeem accordingly. In some embodiments, the method may further include the step of receiving, from a first computer associated with a user, a desired cash value and a desired number of points value of the stored value payment device upon the user receiving the determined equivalent value. For example, the user may receive their number of points the user has available for purchases, and that number may not be high enough to receive their desired value. Therefore, the user may wish to make up the balance by adding a cash value to the stored value payment card in addition to the number of loyalty program points available.

In some embodiments, if the user's number of points the user has available for purchases is not high enough to obtain the desired value of the stored value payment device, the method may perform the additional step of performing additional checks to determine if the user qualifies to purchase the stored value payment device with a combination of loyalty program points and cash. For example a user may only have an available balance of 500 loyalty points. The desired value may be $50 or 5,000 points (based on a 100 points/$ pricing factor). If the user is qualified to use a combination of points and cash, they may be able to utilize their balance of 500 points in addition to spending $45 to meet the balance. If the user qualifies for this feature, the method may return the number of points that the member will need to redeem as well as the cash equivalent amount to meet the balance.

Block S240 recites debiting a number of loyalty program points from user's loyalty program account. Block S250 recites creating a stored value payment device having an initial real-time debitable balance equal to a cash value. Blocks S240 and S250 preferably function to “transfer” the loyalty program points from the loyalty program account of the user to the stored value payment device. Debiting the number value of loyalty program points from the loyalty program account of the user is preferably performed in real-time, although transferring points from the loyalty program account of the user can be performed in any suitable manner.

In one variation, the stored value payment device is a payment instrument compatible with near field communication (NFC) enabled devices, such as mobile phones. For example, the stored value payment device can be a payment instrument usable with an e-commerce agent such as a mobile wallet and branded or otherwise associated with the loyalty program (e.g., with logos or other aspects of “look and feel”). However, the stored value payment device can be a standalone payment instrument and/or generic payment instrument, such as a general-use VISA® card.

In a first variation, creating a stored value payment device S250 creates the stored value payment device as a standalone payment instrument (e.g., embedded within a mobile application on a mobile device) that stores the equivalent cash value of the debited number of loyalty program points. In particular, the stored value payment device of the second variation can be operated independently of a central server handling real-time transactions. The stored value payment device is preferably displayed on the mobile phone to the user with logos or other “look and feel” features of the particular loyalty program, which clearly associates the stored value payment device with the loyalty program. Alternatively, the payment device can be displayed as an unbranded generic payment device (such as a general-use VISA® card) or as a customized payment device (such as with an uploaded photo or unique message).

As shown in FIG. 7, in a second variation, creating a stored value payment device S250 creates the stored value payment device as a payment instrument compatible with a mobile phone or other NFC-enabled device; for example, the stored value payment device can be a payment instrument usable with a mobile wallet. Like the first variation of S250, the payment device is preferably displayed or otherwise branded to clearly associate the payment device with the loyalty program, but can alternatively be displayed as an unbranded generic payment device or customized payment device. In this second variation, the method preferably includes block S252, which recites linking the equivalent cash value (of the debited number of loyalty program points) to an NFC tag and/or NFC-enabled device, such as a mobile phone. The process of creating an NFC tag is known and readily understood by one of ordinary skill in the art. Alternatively, the method can include linking the equivalent cash value of the debited number of loyalty program points to an instrument of another suitable communications standard, such as RFID or Bluetooth.

In a third variation, creating a branded stored payment S250 create (or facilitate creation of) a physical card (similar to a physical gift card loaded with cash value) having the determined equivalent cash value of the number of loyalty program points.

In some embodiments, the created stored value payment device has no merchant restrictions and can be accepted as payment at any merchant. In some other embodiments, the stored value payment device is restricted to use at one or more particular merchants. The stored value payment device can additionally or alternatively include other specifications such as an expiration date, or other limitations. In some embodiments, block S250 includes dividing the determined equivalent cash value into multiple stored value payment devices.

After receiving a stored value payment device branded by the loyalty program, the user preferably is able to make a purchase using the stored value payment device at one or more merchants using his or her NFC-enabled device (or other suitable carrier of the stored value payment device). During purchase, the NFC reader at the merchant preferably completes the purchase transaction and debits the purchase amount from the stored value payment device. The stored value payment device can be configured such that after the transaction is complete, the user is able to view a notification message summarizing the purchase amount was debited from the stored value payment device.

The system and method of the preferred embodiment can be embodied and/or implemented at least in part as a machine configured to receive a computer readable medium storing computer-readable instructions. The instructions are preferably executed by computer-executable components preferably integrated with the system. The computer-readable medium can be stored on any suitable computer readable media such as RAMs, ROMs, flash memory, EEPROMs, optical devices (CD or DVD), hard drives, floppy drives, or any suitable device. The computer-executable component is preferably a general or application specific processor but any suitable dedicated hardware device or hardware/firmware combination device can (alternatively or additionally) execute the instructions. Although omitted for clarity, the preferred embodiments of the method include every combination and permutation of the processes described herein. It should be understood that any of the foregoing processes can be performed by any suitable device, in any suitable order, in a serial or parallel manner.

### Example Implementation of the System and Method

The following example implementation of the preferred system and method is for illustrative purposes only, and should not be construed as definitive or limiting of the scope of the claimed invention. In one illustrative example, a member of Loyalty Program X would like to create a stored value payment device using his loyalty program points (frequent flyer miles). The member navigates to a user interface hosted on the website of Loyalty Program X and logs into his loyalty program account with Loyalty Program X using his member identification information. The controller of the system authenticates and links to the loyalty program account of the member, with access to the loyalty program profile and miles balance of the member. The member enters his choice of creating a stored value payment device using 25,000 miles worth of value. The rules engine determines, through the pricing factors database, that the applicable pricing factor for this member and this number of miles is $0.01/point. The controller converts the 25,000 miles into an equivalent cash value of $250 (25,000×0.01=250), and the payment device creator module loads the $250 onto a payment device having an NFC tag compatible with NFC-readers. The payment device creator module also facilitates debiting the 25,000 miles from the user's loyalty program X account.

In an illustrative example of use of the stored value payment device, the member carries a NFC-enabled mobile phone, on which the stored value payment device is stored in an electronic payment wallet, to a merchant such as a café with an NFC reader. The member orders a latte for $2.50 at the café, and presents his NFC-enabled mobile phone, with the stored value payment device, as a primary form of payment. The NFC reader at the café determines that there is $250 cash value stored on the stored value payment device, and the member agrees to pay $2.50 worth of stored value on the stored value payment device. The NFC reader at the café completes the transaction and debits $2.50 from the stored value payment device through the mobile phone of the member. The member is then able to view on his mobile phone a confirmation message such as “You used 250 miles for your coffee, which had a cash value of $2.50.” In order to debit $2.50 from the stored value payment device through the mobile phone of the member, the mobile phone will not be required to communicate with any external system (e.g. the loyalty program or controller of the system described herein) at the point of sale. For example, the mobile phone will not be required to communicate with the loyalty program or controller of the system described herein to retrieve real-time point balance and/or conversion factors. All communication with the loyalty program or controller of the system described herein was completed at the time of creation of the stored value payment device.

As a person skilled in the art will recognize from the previous detailed description and from the figures and claims, modifications and changes can be made to the preferred embodiments of the invention without departing from the scope of this invention defined in the following claims.

We claim:

1. A method for enabling use of loyalty program points as a stored value payment device, the method comprising the steps of:
receiving, from a first computer associated with a user, a desired value of the stored value payment device;
determining a pricing factor applicable to at least one of the user and the desired value of the stored value payment device;
converting the desired value of the stored value payment device based on the pricing factor to an equivalent value;
sending, to the first computer associated with the user, the determined equivalent value;
debiting a number of loyalty program points from user's loyalty program account; and
creating a stored value payment device having an initial real-time debitable balance equal to a cash value.

2. The method of claim 1, wherein the receiving step comprises receiving a desired cash value of the stored value payment device; the converting step comprises converting the desired cash value of the stored value payment device based on the pricing factor to an equivalent number of loyalty program points; and the sending step comprises sending the determined equivalent number of loyalty program points.

3. The method of claim 1, wherein the receiving step comprises receiving a desired number of loyalty program points of the stored value payment device; the converting step comprises converting the desired number of loyalty program points of the stored value payment device based on the pricing factor to an equivalent cash value; and the sending step comprises sending the determined equivalent cash value.

4. The method of claim 1, wherein the receiving step comprises the steps of presenting a user interface to a user and receiving at least one of a cash value and a number of loyalty program points from the user through the user interface.

5. The method of claim 1, further comprising the step of verifying that the received desired value is a valid desired value input.

6. The method of claim 1, further comprising the step of determining the number of available loyalty program points in the user's loyalty program account.

7. The method of claim 6, further comprising the step of displaying the number of available loyalty program points in the user's loyalty program account.

8. The method of claim 1, further comprising the step of receiving a merchant selection.

9. The method of claim 8, wherein the creating step comprises creating a stored value payment device associated with the at least one merchant selected.

10. The method of claim 1, wherein the creating step comprises creating a physical card having a cash value.

11. The method of claim 1, wherein the creating step comprises creating a stored value payment device that is a payment instrument compatible with near field communication (NFC) enabled devices.

12. The method of claim 11, wherein the creating step comprises the step of linking the cash value to one of an NFC tag and a NFC-enabled device.

13. The method of claim 11, wherein the creating step comprises creating a stored value payment device that is embedded within a mobile application on a mobile device.

14. The method of claim 1, wherein the creating step comprises creating a stored value payment device that is a payment instrument usable with an e-commerce agent.

15. The method of claim 1, wherein the creating step comprises creating a stored value payment device that is a debit or credit card.

16. The method of claim 1, wherein the creating step comprises creating a stored value payment device that is a branded stored value payment device associated with the loyalty program.

17. A system for enabling use of loyalty program points as a stored value payment device, the system comprising:
a controller coupled to a loyalty program account of a user and configured to:
receive from a user, a desired value of the stored value payment device, and
convert the desired value of the stored value payment device based on a pricing factor to an equivalent value;
a rules engine coupled to the controller and configured to determine the applicable pricing factor; and
a payment device creator module configured to debit a number of loyalty program points from the user's loyalty program account and to create a stored value payment device having an initial real-time debitable balance equal to a cash value.

18. The system of claim 17, further comprising a user interface for display on a computing device and coupled to the controller.

19. The system of claim 18, wherein the user interface is configured to receive an input from the user of the desired value of the stored value payment device.

20. The system of claim 18, wherein the user interface is hosted on a website associated with the loyalty program.

21. The system of claim 18, wherein the user interface is configured to receive user identification information.

22. The system of claim 17, wherein the rules engine is coupled to a pricing factors database that stores a plurality of points-to-cash pricing factors.

23. The system of claim 22, wherein the rules engine searches for, selects, or otherwise determines an applicable pricing factor from the pricing factors database.
